(19) United States
(12) Patent Application Publication
(10) Pub. No.: US 2023/0356808 A1
(43) Pub. Date: Nov. 9, 2023

(54) ELECTRICALLY ASSISTED CRAFT, SUCH AS A SURFBOARD OR PADDLEBOARD

(71) Applicant: MOTION CONCEPT GROUP, Bordeaux (FR)

(72) Inventor: Nicolas QUENDEZ, Chézy-en-Orxois (FR)

(73) Assignee: MOTION CONCEPT GROUP, Bordeaux (FR)

(21) Appl. No.: 17/766,436

(22) PCT Filed: Oct. 2, 2020
(86) PCT No.: PCT/EP2020/077755

§ 371 Date: Apr. 4, 2022

(30) Foreign Application Priority Data
Oct. 2, 2019 (FR) 1910900

(51) Int. Cl. B63B 32/10; B63B 32/40; B63H 21/17; B63H 11/08

(52) U.S. Cl. CPC B63B 32/10; B63B 32/40; B63H 11/08; B63H 21/17; B63H 2011/081

(57) ABSTRACT

The invention relates to an electrically assisted craft which is intended to allow a user to be transported on water, the invention notably finding an application in the field of surfboards, paddleboards or else sailboards, and in the field of kayaks or canoes.

The craft comprises a first and a second housing (4, 5) formed in the craft, propulsion means (3) able to allow the craft to travel over or in the water, an electrical power source arranged inside a first watertight enclosure (1) housed inside the first housing (4) and provided with first electrical-connection means (8), and an electrical motorization system arranged in a second watertight enclosure (2) housed inside the second housing (5) and provided with second electrical-connection means, the source and the electric motorization system being electrically connected by the first and second connection means, the electric motorization system also being connected to the propulsion means, so as to allow the propulsion means to be driven when the drive system is powered with electrical energy by the source.

The first and second enclosures (1, 2) are fixed removably in the first and second housings (4, 5) respectively, the first and second housings (4, 5) respectively having a first and a second outputs allowing the passage of the first and second electric connection means respectively, and being configured to allow direct connection between the first and second electric connection means at the level of the first and/or of the second outputs.

The present invention relates to an electrically assisted craft, intended to allow a user to be transported on water. It finds particular application in the field of surfboards, paddle boards, or even windsurfing boards, as well as in the field of kayaking or canoeing.

For example, a surfboard is intended to allow a user to slide on the water under the propulsion action provided by a wave. Generally, in the absence of a wave in a given area where the user is, the latter, lying on the board, uses his arms to provide the propulsion necessary for the board to reach an area where a wave has formed or is in the process of being training.

Another example consists of a paddle board which, for its part, aims to allow a user to slide on the water under the propelling action of a user equipped with a paddle. As with a surfboard, the paddle board can also allow the user to slide on the water under the propulsion action provided by a wave.

Other examples exist of crafts that allow a user to navigate on water, by means of a mechanical propulsion action that the user himself provides directly or by means of a means such as a or more paddles or oars, and/or by means of a propulsive action provided by the environment such as wind or a wave.

To facilitate the use of these crafts, in particular to facilitate propulsion in areas or at times where the mechanical propulsion action provided by the user or by the environment is not sufficient, these crafts can be equipped with electric assistance, i.e. an electric motorization system that drives mechanical propulsion means such as a propeller.

We therefore already know crafts such as electrically assisted surfboards or paddle boards, which generally include means of propulsion, such as a propeller, to allow the craft to progress on or in the water, a source of electrical energy, such as an electric battery, received in a housing on the upper surface of the craft, and an electric motorization system received on the lower surface of the craft. The motorization system is connected on the one hand to the source and on the other hand to the means of propulsion. Thus, when the motorization system is supplied with electrical energy by the source, it drives the means of propulsion, allowing the movement of the craft on or in the water.

The architecture of these crafts can be designed to separately integrate the source and the motorization system, with complicated arrangements in terms of watertightness and electrical interconnection. Manipulations to connect and disconnect the source and the motorization system can be tedious, and the interconnecting elements can quickly be damaged.

Alternatively, the source and the motorization system can be already interconnected in a bulky assembly forming an electric assistance unit, housed in the craft. Such an architecture, however, makes maintenance more difficult since it requires access to the entire block to intervene on one or other of the elements. Furthermore, such a block is difficult to remove.

One of the aims of the invention is therefore to solve in particular the aforementioned problems. Thus, the object of the invention is in particular to propose a craft, such as a surfboard or paddle board, with electrical assistance, whose architecture facilitates assembly as well as maintenance.

The craft has a first and a second side intended respectively to receive a user and to be placed on, or immersed in, water.

The craft comprises a first and a second housing formed in the craft respectively on the first and on the second sides, means of propulsion able to allow the progression of the craft on or in the water, a source of electrical energy arranged in a first watertight enclosure housed in the first housing and provided with first electrical connection means, and an electric motorization system arranged in a second watertight enclosure housed in the second housing and provided with second electrical connection means, the source and the system motorization being electrically connected by the first and second connection means, the motorization system also being connected to the propulsion means, so as to allow the drive of the propulsion means when the motorization system is supplied with electrical energy by the source.

The first and second enclosures are removably fixed respectively in the first and second housings, the first and second housings having respectively a first and a second outputs to allow the passage respectively of the first and second connection means, the first and second housings being configured to allow direct connection between the first and second connection means at the first and/or second outputs.

According to certain embodiments, the craft also comprises one or more of the following characteristics, taken separately or in all technically possible combinations:
the craft comprises a first and a second receptacle fixed, or fastened, respectively in the first and second housings, and the first and second enclosures are fixed, or fastened, in a removable manner respectively in the first and second receptacles, the first and second receptacles respectively having a first and a second output respectively arranged at the level of the first and second outputs respectively of the first and second housing;
the craft comprises locking and unlocking means, for locking and unlocking the first enclosure in the first housing, or in the first receptacle, the locking and unlocking means being able to adopt a locked position in which the first enclosure cannot be removed from the first housing, respectively from the first receptacle, and an unlocked position in which the first enclosure can be removed from the first housing, respectively from the first receptacle;
the locking and unlocking means form a hatch which is closed in the locked position of the locking and unlocking means so as to prevent access to the first and/or second connection means, and which is open in the unlocked position of the locking and unlocking means so as to allow access to the first and/or second connection means;
a third housing is formed in the craft and communicates respectively with the first and second housings respectively via the first and second outputs respectively of said first and second housings;
the third housing forms a tunnel having two opposite end openings and connecting respectively, by its said two opposite end openings, the first and second outputs respectively of the first and second housings, the tunnel being moreover opened by a longitudinal opening oriented towards the first or the second side;
the third housing is configured to allow passage from the second connection means to the first connection means, the direct connection between the first and second connection means then being made at the first output;
the craft comprises a third receptacle fixed in the third housing, and the direct connection between the first and second connection means is made in the third receptacle, this third receptacle communicating respectively with the first and second receptacles respectively via the first and second outputs respectively of said first and second receptacles;
the third housing is formed on the first side, the third receptacle is formed integrally with the first receptacle, connected in a watertight manner, for example by gluing, to the second receptacle;
the third housing is formed on the second side, the third receptacle is formed integrally with the second receptacle, connected in a watertight manner, for example by gluing, to the first receptacle;
the first, second and third receptacles form an integral assembly;
the third receptacle forms a tunnel having two opposite end openings communicating respectively with the first and second outputs respectively of the first and second receptacle, the tunnel being furthermore opened by a longitudinal opening oriented towards the first or the second side;
the third receptacle is closed by a lid;
the second enclosure is extended into a turbine in which the means of propulsion are arranged;
the craft comprises means for locking and unlocking the direct connection between the first and second connection means;
the motorization system comprises, inside the enclosure, a motor and electronic control means configured to allow to control the operation of the motor and its electrical supply by the source, the control means being connected to the second means connection;
the craft has a first and a second side intended respectively to receive a user and to be placed on, or immersed in, the water, the first and the second housing being formed in the craft respectively of one and the other of the first and second sides, preferably the first and the second side respectively;
the craft has a first and a second side intended respectively to receive a user and to be placed on, or immersed in, the water, the first and the second housing being formed in the craft of one or more other of the first and second sides;
the first and/or the second housing is or are through from one to the other of the first and second sides.

Thus, the architecture of the craft of the invention makes the assembly easy to assemble, and makes maintenance interventions on the source, such as a battery, or on the motor, easier and faster.

Indeed, access to the connection between the source and the motor is facilitated, and the connection/disconnection between the source and the motor can be achieved by simple gestures, while guaranteeing watertightness.

The characteristics and advantages of the invention will appear on reading the following description, given solely by way of example, and not limiting, with reference to the following appended figures:

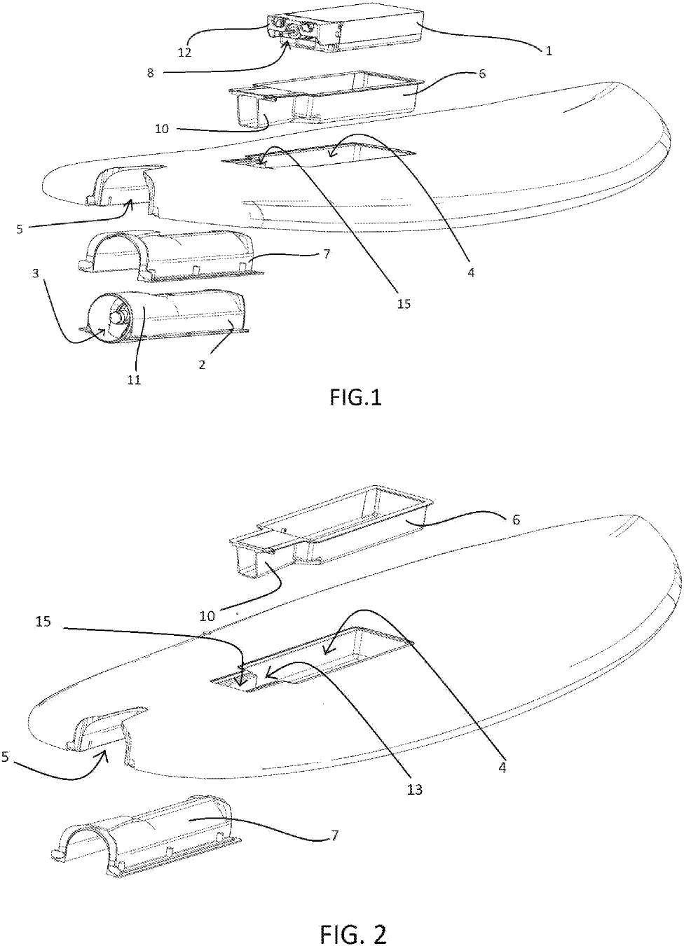

FIG. 1: schematic representation of an example of a craft according to the invention;

FIG. 2: schematic representation of part of the craft of FIG. 1, seen from a first side, during assembly of various components;

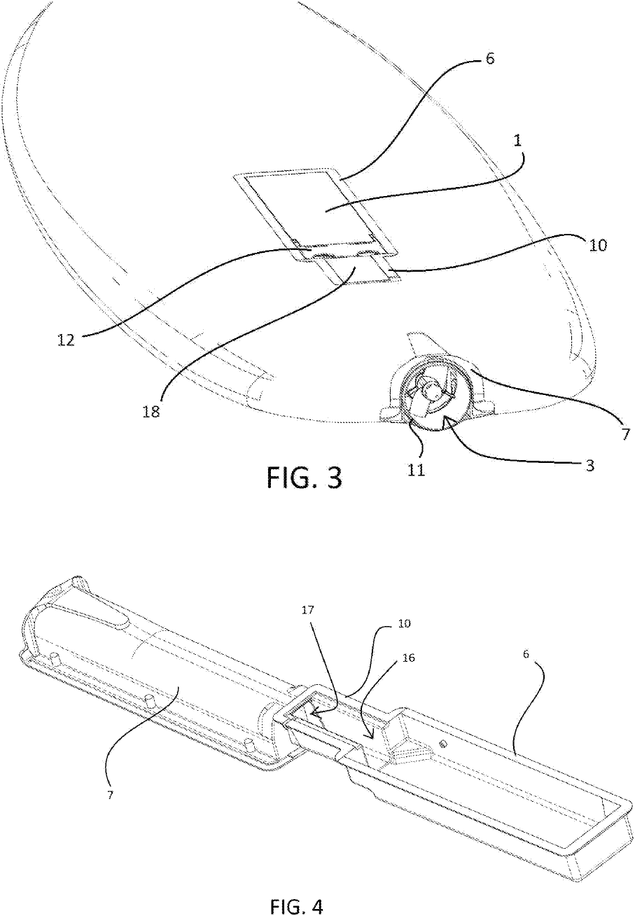

FIG. 3: schematic representation of part of the craft of FIG. 1, seen from the first side, after assembly of various components;

FIG. 4: schematic representation of a component of the embodiment of FIG. 1;

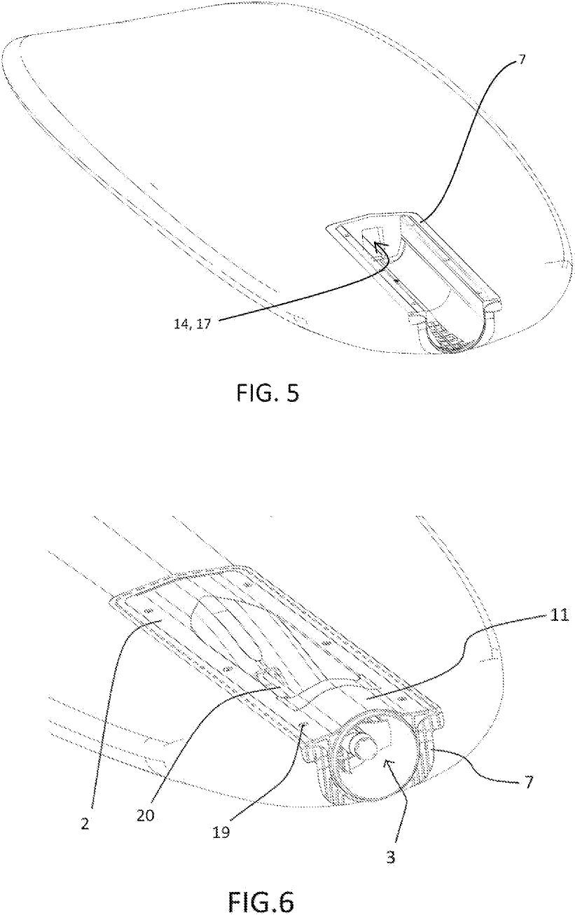

FIG. 5: schematic representation of part of the craft of FIG. 1, seen from a second side, during assembly of various components;

FIG. 6: schematic representation of part of the craft of FIG. 1, seen from the second side, after assembly of various components

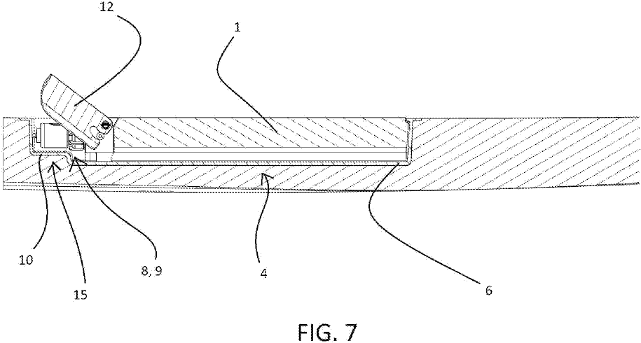

FIG. 7: schematic representation of an example of locking the connection of the source of electrical energy.

With reference to these figures, an embodiment of a craft according to the invention is therefore described below. Specifically, in this example, the craft is of the surfboard or paddleboard type.

In this example, on the first side, intended to receive a standing or seated user, a first housing 4 is formed. On the second side, intended to be placed on, or immersed in, water, is formed a second housing 5.

A source 1 of electrical energy, such as a battery, is arranged in a first enclosure also referenced 1. This first enclosure 1 is watertight, and housed in the first housing 4. This first enclosure 1 is also provided with first electrical connection means 8, visible in particular in FIGS. 1 and 7.

On the other hand, an electric motorization system 2 is arranged in a second enclosure also referenced 2. This second enclosure 2 is watertight, and housed in the second housing 5. This second enclosure 2 is also provided with second electrical connection means 9, visible in particular in FIG. 7.

Other configurations are possible concerning the distribution of the first and second housings 4, 5 on the craft, than that shown in the figures.

For example, the first housing 4 intended to receive the first enclosure 1 can be placed on the second side, whereas the second housing 5 intended to receive the second enclosure 2 can be placed on the first side.

Also, the first and second housings 4, 5 can both be arranged on the same side, the first or the second.

Also still, one or the other of the first and second housings 4 and 5, or both, can take the form of through housings from the first side to the second side of the craft.

The source 1 and the motorization system 2 are electrically connected by the first and second connection means 8, 9.

Means of propulsion 3, such as a propeller 3, are provided to allow the progression of the craft on or in the water. These propulsion means 3 are connected to the motorization system 2, for example via a shaft 20 visible in FIG. 6, so as to allow the drive of the propulsion means 3 when the motorization system 2 is powered with electrical energy by source 1.

The first and the second enclosures 1, 2 are both removably fixed or fastened in their respective housings 4, 5. By way of example, as shown in FIG. 6, the second enclosure 2 is fastened in a removable manner in the second housing via removable fastening means 19 and a receptacle 7 which will be described in detail below.

Furthermore, the first and the second housing 4, 5 each have an output, in this case the first output 13 for the first housing represented in particular in FIG. 2, and the second output 14 for the second housing represented in particular in FIG. 5. That first and this second outputs 13, 14 allow the passage respectively of the first and second connection means 8, 9.

Thus, the first and the second housings 4, 5 are configured to allow direct connection between the first and second connection means 8, 9 at the level of this first and/or second outputs 13, 14. More specifically, in the example shown in the figures, the first and second housings 4, 5 are configured to allow direct connection between the first and second connection means 8, 9 at the level of the first output 13. But other configurations are possible, with a direct connection between the first and second connection means 8, 9 at the level of the second output 14, or at the level of the two outputs 13 and 14.

Furthermore, by direct connection at one or other of the outputs 13 and 14, is meant a direct connection of the connection means 8, 9 on one side or the other of the output or outputs concerned. Thus, in the example shown in the figures, the direct connection between the first and second connection means 8, 9 is made at the level of the first output 13 of the first housing 4, inside this first housing 4. In another variant, the direct connection between the first and second connection means 8, 9 at the level of the first output 13 of the first housing 4 could be made outside this first housing 4.

As can be seen more specifically in FIGS. 1 and 7 in particular, locking and unlocking means 12 are provided, allowing on the one hand to hold the first enclosure 1 in place in the first housing 4, or in the first receptacle 6 in the embodiment shown in the figures in which the first enclosure 1 is fixed in the first receptacle 6 itself fixed in the first housing 4, and allowing on the other hand the removal of the first enclosure 1 from the first housing 4 (or from the first receptacle 6 in the example shown).

Thus, these locking and unlocking means 12 can adopt a locked position (see FIG. 1: exploded view) in which the first enclosure 1 cannot be removed from the first housing 4, respectively from the first receptacle 6, and an unlocked position (see FIG. 7) in which the first enclosure 1 can be removed from the first housing 4, respectively from the first receptacle 6.

In the example shown in the figures, these locking and unlocking means 12 form a hatch 12 which is closed in the locked position of the locking and unlocking means 12 so as to prevent access to the first and/or second means of connection 8, 9, and which is open in the unlocked position of the locking and unlocking means 12 so as to allow access to the first and/or second connection means 8, 9.

In a particular embodiment, corresponding to that shown in the figures, receptacles 6, 7 are used to respectively house the first enclosure 1, therefore the source 1, and the second enclosure 2, therefore the motorization system 2, in their respective housings 4, 5 formed in the craft.

Thus, the first and second enclosures 1, 2 are removably fastened respectively in the first and second receptacles 6, 7.

Furthermore, the first receptacle 6 has a first output 16, visible in FIG. 4. Once the first receptacle 6 is in position in the first housing 4, the first output 16 of this first receptacle 6 is located at the level of the first output 13 of the first housing 4 (visible in FIG. 2).

Also, the second receptacle 7 has a second output 17, visible in FIG. 5. Once the second receptacle 7 is in position in the second housing 4, the second output 17 of this second receptacle 7 finds itself disposed at the level of the first output 14 of the second housing 5, as shown in FIG. 5.

As can be seen in the figures, a third housing 15 is formed in the craft. This third housing 15 communicates with the first and second housings 4, 5. More precisely, the third housing 15 communicates with the first housing 4 via the first output 13 of this first housing 4. Furthermore, the third housing 15 communicates with the second housing 5 via the second output 14 of this second housing 5.

As can be seen in the figures, the third housing 15 forms a kind of tunnel 15 having two opposite end openings. Each of these opposite end openings allows to connect this tunnel 15 respectively to the first and second housing 4, 5, by the respective first and second outputs 13, 14 of these first and second housings 4, 5.

The tunnel 15 is also opened by a longitudinal opening oriented towards the first or the second side, in this case the first side in the example shown in the figures.

The third housing or tunnel 15 is configured to allow the passage of the second connection means 9 to the first connection means 8. The direct connection between the first and second connection means 8, 9 is then made at the level of the first output 13.

In the embodiment in which receptacles 6 and 7 are used to respectively house the first enclosure 1 and the second enclosure 2 in the first housing 4 and the second housing 5, a third receptacle 10 is provided which is fastened in the third housing 15.

As can be seen in the figures, this third receptacle 10 communicates with the first and second receptacles 6, 7. More precisely, the third receptacle 10 communicates with the first receptacle 6 via the first output 16 of this first receptacle 6. Also, the third receptacle 10 communicates with the second receptacle 7 via the second output 17 of this second receptacle 7.

As seen above, in the example shown in the figures, the third housing 15 is formed on the first side, therefore on the same side as the side in which the first housing 4 is formed which receives the first enclosure 1.

The third receptacle 10 is then preferably formed integrally with the first receptacle 6, and connected in a watertight manner, for example by gluing, to the second receptacle 7.

Alternatively, the third housing 15 is formed on the second side, therefore on the side in which the second housing 5 receiving the second enclosure 2 is formed.

The third receptacle 10 is then preferably formed integrally with the second receptacle 7, and connected in a watertight manner, for example by gluing, to the first receptacle 6.

Optionally, the first, second and third receptacles 6, 7 and 10 can form an integral assembly.

As can be seen in the figures, the third receptacle 10 forms a kind of tunnel 10 having two opposite end openings. Each of these opposite end openings allow to connect this tunnel 10 respectively to the first and second receptacles 6, 7, via the respective first and second outputs 16, 17 of these first and second receptacles 6, 7.

The tunnel 10 is also opened by a longitudinal opening oriented towards the first or the second side, namely the first side in the example shown in the figures.

The third receptacle 10 can be closed by a lid 18, visible in FIG. 3, to protect the passage from the second connection means 9 to the first connection means 8.

As can be seen for example in FIGS. 1, 3 and 6, the second enclosure 2, 11 comprises a part 2 acting as an actual enclosure for the motorization system 2, and is extended into a part 11 acting as a turbine 11 in which the means of propulsion 3 are arranged.

The enclosure part 2 and the turbine part 11 are preferably formed integrally. They therefore form an integral assembly 2, 11 which is generally called the second enclosure, even if only part 2 acts as the second enclosure within the meaning of the invention.

Means for locking and unlocking the direct connection between the first and second connection means 8, 9 can be provided, for example by a quarter-turn type lock system.

The motorization system 2 comprises, inside the enclosure 2, a motor and electronic control means. The motor is connected to the means of propulsion 3 by the shaft 20 visible in FIG. 6. The electronic control means are configured to allow to control the operation of the motor and its electrical supply by the source 1, and are connected to the second connection means 9.

It is reminded that this description is given by way of example, and does not limit the invention.

In particular, and although finding a particularly interesting application in the field of surfboards, the invention is not limited to a surfboard-type craft, but extends to craft such as a paddleboard or a sail craft. More generally, the invention is not limited to a craft of the board type, but extends to any craft with electrical assistance, such as a canoe or a kayak.

1. An electrically assisted craft comprising a first and a second housing formed in the craft, propulsion means able to allow the progression of the craft on or in the water, a source of electrical energy arranged in a first watertight enclosure housed in the first housing and provided with first electrical connection means, an electric motorization system arranged in a second watertight enclosure housed in the second housing and provided with second electrical connection means, the source and the electric motorization system being electrically connected by the first and second electric connection means, the electric motorization system also being connected to the propulsion means, so as to allow the driving of the propulsion means when the electric motorization system is supplied with electrical energy by the source,
wherein the first and second watertight enclosures are removably fastened respectively in the first and second housings, the first and second housings respectively having a first and a second outputs to allow the passage respectively of the first and second electric connection mean, the first and second housings being configured to allow the direct connection between the first and second electric connection means at the level of the first and/or the second outputs.

2. The electrically assisted craft according to claim 1, further comprising a first and a second receptacles fastened respectively in the first and second housings, the first and second watertight enclosures being removably fastened respectively in the first and second receptacles, and the first and second receptacles having respectively a first and a second outputs arranged respectively at the level of the first and second outputs respectively of the first and second housing.

3. The electrically assisted craft according to claim 1, further comprising locking and unlocking means for locking and unlocking the first watertight enclosure in the first housing, the locking and unlocking means being able to adopt a locked position in which the first watertight enclosure cannot be removed from the first housing, and an unlocked position in which the first watertight enclosure can be removed from the first housing.

4. The electrically assisted craft according to claim 3, wherein the locking and unlocking means form a hatch which is closed in the locked position of the locking and unlocking means so as to prevent access to the first and/or second electric connection means, and which is open in the unlocked position of the locking and unlocking means so as to allow access to the first and/or second electric connection means.

5. The electrically assisted craft according to claim 1, wherein a third housing is formed in the craft and communicates respectively with the first and second housings respectively via the first and second outputs respectively of said first and second housings.

6. The electrically assisted craft according to claim 5, wherein the third housing forms a tunnel having two opposite end openings and connecting respectively, by its said two opposite end openings, the first and second output respectively of first and second housings, the tunnel being further opened by a longitudinal opening.

7. The electrically assisted craft according to claim 5, wherein the third housing is configured to allow passage of the second electric connection means toward the first electric connection means, the direct connection between the first and second electric connection means then being made at the level of the first output.

8. The electrically assisted craft according to claim 5, further comprising a third receptacle fastened in the third housing this said third receptacle communicating respectively with the first and second receptacles respectively via the first and second outputs respectively of said first and second receptacles.

9. The electrically assisted craft according to claim 8, wherein the third housing is formed on the first side, and wherein the third receptacle is formed integrally with the first receptacle and connected in a watertight manner to the second receptacle.

10. The electrically assisted craft according to claim 8, wherein the third housing is formed on the second side, and wherein the third receptacle is formed integrally with the second receptacle and connected in a watertight manner to the first receptacle.

11. The electrically assisted craft according to claim 8, wherein the first, second and third receptacles form an integral assembly.

12. The electrically assisted craft according to claim 5, wherein the third receptacle forms a tunnel having two opposite end openings communicating respectively with the first and second outputs respectively of the first and second receptacle, the tunnel being furthermore opened by a longitudinal opening oriented towards the longitudinal opening of the third housing.

13. The electrically assisted craft according to claim 12, wherein the third receptacle is closed by a lid.

14. The electrically assisted craft according to claim 1, wherein the second watertight enclosure extends into a turbine in which the propulsion means are arranged.

15. The electrically assisted craft according to claim 1, further comprising means for locking and unlocking the direct connection between the first and second electric connection means.

16. The electrically assisted craft according to claim 1, wherein the electric motorization system comprises, inside the watertight enclosure, a motor and electronic control means configured to allow to control the operation of the motor and its electrical supply by the source, the electronic control means being connected to the second electric connection means.

17. The electrically assisted craft according to claim 1 further comprising a first and a second sides intended respectively to receive a user and to be placed on, or immersed in, water, the first and second housings being formed in the craft respectively on one and the other of the first and second sides.

18. The electrically assisted craft according to claim 1, further comprising a first and a second sides intended respectively to receive a user and to be placed on, or immersed in, water, the first and second housings being formed in the craft on either of the first and second sides.

19. The electrically assisted craft according to claim 17, wherein the first and/or the second housing is or are through from one to the other of the first and second sides.

20. The electrically assisted craft according to claim 18, wherein the first and/or the second housing is or are through from one to the other of the first and second sides.

21. The electrically assisted craft according to claim 1, said craft being a surfboard or a paddleboard.

22. The electrically assisted craft according to claim 2, further comprising locking and unlocking means for locking and unlocking the first watertight enclosure in the first receptacle, the locking and unlocking means being able to adopt a locked position in which the first watertight enclosure cannot be removed from the first receptacle, and an unlocked position in which the first watertight enclosure can be removed from the first receptacle.
